(19) United States
(12) Patent Application Publication
(10) Pub. No.: US 2020/0062060 A1
(43) Pub. Date: Feb. 27, 2020

(54) LINKING DEVICE BETWEEN AN ALUMINIUM SIDE RAIL OF A VEHICLE AND A CONTROL ARM

(71) Applicant: RENAULT s.a.s., Boulogne-Billancourt (FR)

(72) Inventors: Maxime CHEVALIER, Voisins le bretonneux (FR); Christophe ESTIOT, Dreux (FR)

(73) Assignee: RENAULT s.a.s., Boulogne-Billancourt (FR)

(21) Appl. No.: 16/466,132

(22) PCT Filed: Nov. 29, 2017
(86) PCT No.: PCT/EP2017/080756

§ 371 Date: Jun. 3, 2019

(30) Foreign Application Priority Data
Dec. 6, 2016 (FR) 1661998

(51) Int. Cl. B60G 7/02; B60G 7/00; B62D 25/20; B62D 21/11; B62D 65/12

(52) U.S. Cl. CPC B60G 7/02; B60G 7/001; B62D 65/12; B62D 21/11; B62D 25/2036

(57) ABSTRACT

A linking device links an aluminum side rail of a vehicle body structure and an end of a control arm that includes a cylindrical linking ring. The device remarkably includes an aluminum casting including an upper surface attached under the side rail, and a side wall from which emerges, perpendicular to an outer side surface, at least one first control arm interface including a pair of tabs separated from one another by an air-gap value greater than the length of the cylindrical ring, in order to set the end of the control arm.

The present invention relates to a device for connection between an aluminum lateral side rail of a vehicle body structure, in particular a motor vehicle body structure, and an end of a suspension arm which comprises a cylindrical articulation ring.

For reasons of lightening, the blank body of the vehicle is made of aluminum. The underbody of the body then comprises mostly a composition of aluminum profiles assembled by means of adhesion, riveting and/or welding, in particular for the parts which are subjected to high levels of mechanical and/or thermal stresses.

The objective is to obtain a solution for reinforcement of the underbody, and in particular of the rear side rails, for a vehicle wherein the engine assembly is disposed at the rear. The suspension functions must also be able to be assembled in this area.

In general, vehicles are designed by assembling stamped steel parts. In fact, steel can easily be stamped, and makes it possible to obtain strong parts. The side rails and the rear cradle thus constitute in a manner known per se a structure made of stamped parts. Similarly, the parts which perform the suspension functions are assembled on parts made of bent or stamped steel, added onto the structure.

Within the context of lightening the structure, the use of extruded profiles limits the possibilities of interfacing the suspension elements. Aluminum casting then becomes an advantageous process.

Document FR2890641A1 discloses lateral parts of underframes which are made by molding of aluminum under pressure, and welded to a central part of the underframe produced in the form of an extruded aluminum profile. Molding under pressure is more suitable for production of thin parts than bulky parts. The thinness has the disadvantage of lessening the strength, which disadvantage the prior document proposes eliminating by providing reinforcement ribs. The mounting of an engine assembly on the underframe disclosed poses numerous problems, such as, for example, the support and passage of the drive shaft towards the wheels, or else that of transmission of vibrations by the articulations of a suspension arm.

In order to eliminate the problems of the prior art, the subject of the invention is a device for connection between an aluminum lateral side rail of a vehicle body structure and a suspension arm end which comprises a cylindrical articulation ring. The device is noteworthy in that it comprises an aluminum casting comprising an upper face which is secured below the side rail, and a lateral wall from which there extends perpendicularly to an outer lateral face at least a first suspension arm interface comprising a pair of fins which are spaced apart from one another by an air gap value greater than the length of the cylindrical ring, so as to mount the suspension arm end.

In particular, the first suspension arm interface comprises a pair of fins which form an integral part of the aluminum casting, with subjection to a machining operation after leaving the foundry.

More particularly, the pair of fins comprises a first fin with a bulky base in order to maintain its position rigidly, and a second fin, with a thinned base, in order to allow its opposite end to be oriented towards the first fin, so as to clamp said cylindrical ring between the two fins.

Also more particularly, the device comprises at least one wedge inserted between an end of the cylindrical ring and an inner face of the pair of fins.

Again more particularly, two wedges are connected by a small bar.

Also particularly, the aluminum casting comprises a clamp rocker bar interface which comprises a pair of fins in order to mount an end of the clamp rocker bar, and which forms an integral part of the aluminum casting, with subjection to a machining operation after leaving the foundry.

Also particularly, the first or a second suspension arm interface comprises a steel clevis which comprises a pair of fins and is screwed onto the aluminum casting.

Advantageously, the device comprises a screw which passes through the fins and the cylindrical articulation ring in order to reduce by clamping the air gap value of the pair of fins of a single suspension arm interface.

In particular, each fin comprises an oblong window with a length substantially parallel to the upper face of the aluminum casting, such that it is possible to bring the cylindrical articulation ring, and consequently the suspension arm end of the aluminum casting, closer and further away by sliding the screw body in the oblong window.

More particularly, the screw comprises an eccentric disk in order to be placed against a fin face which comprises at least one slide against which the portion of the eccentric disk is applied, such that it is possible to slide the body of the screw in the oblong window by turning the screw.

Other characteristics and advantages of the invention will be better understood upon reading the description of an embodiment which is in no way limiting, and is illustrated by the appended drawings, in which:

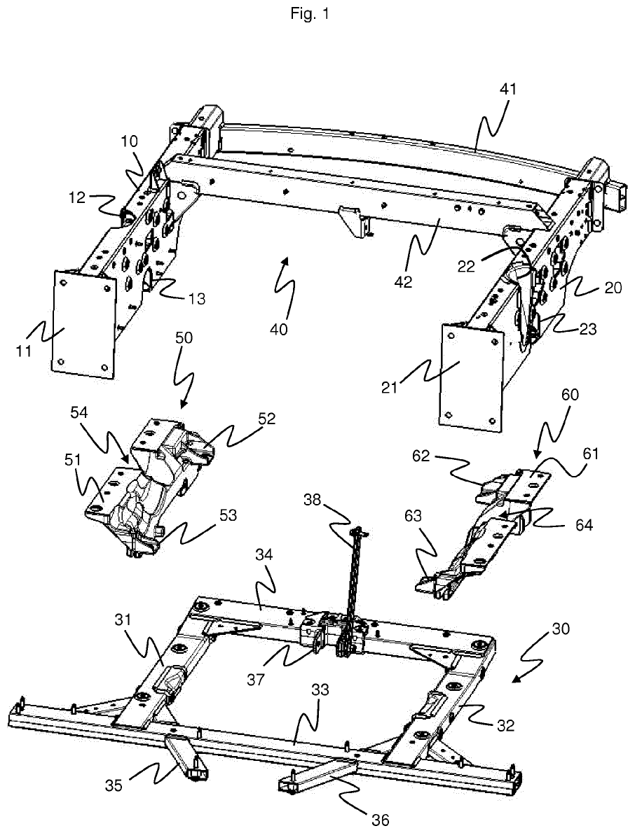

FIG. 1 is an exploded schematic view in perspective of an assembly of a cradle on a body to which the invention is applicable;

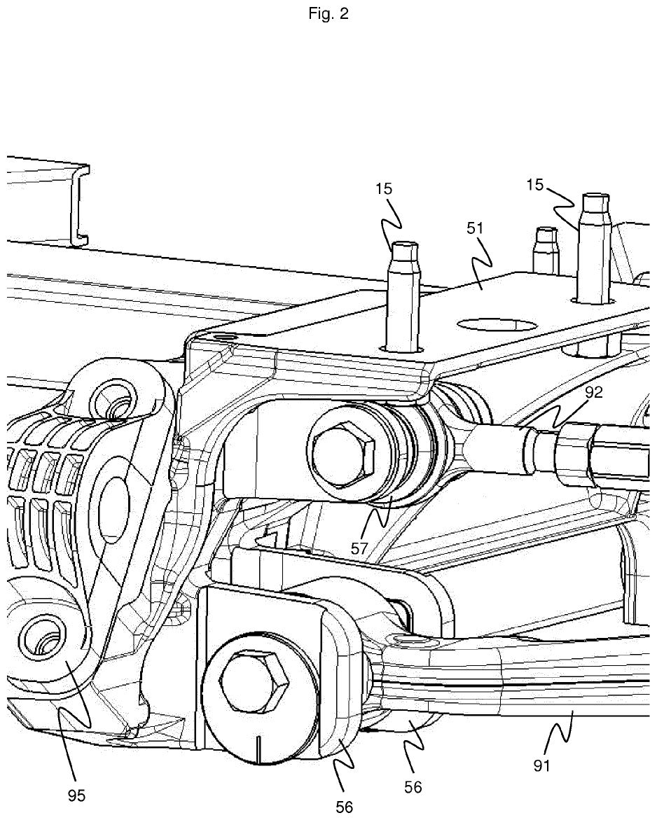

FIG. 2 is a schematic view in perspective of a detail of a casting illustrating the main suspension functions combined with the assembly functions of FIG. 1;

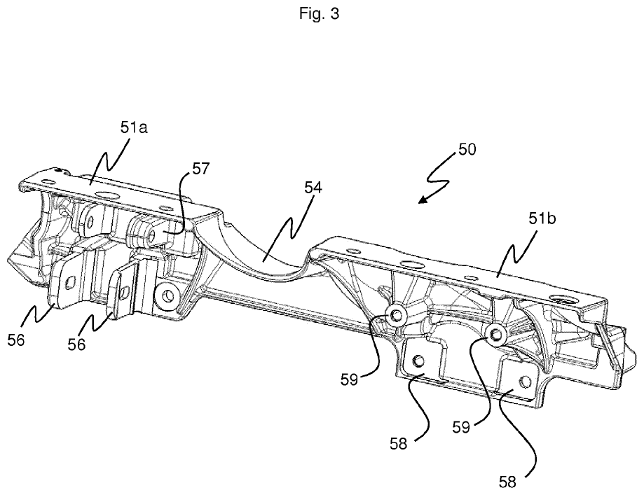

FIG. 3 is a schematic view in perspective of an outer face of the casting designed for fitting of suspension elements;

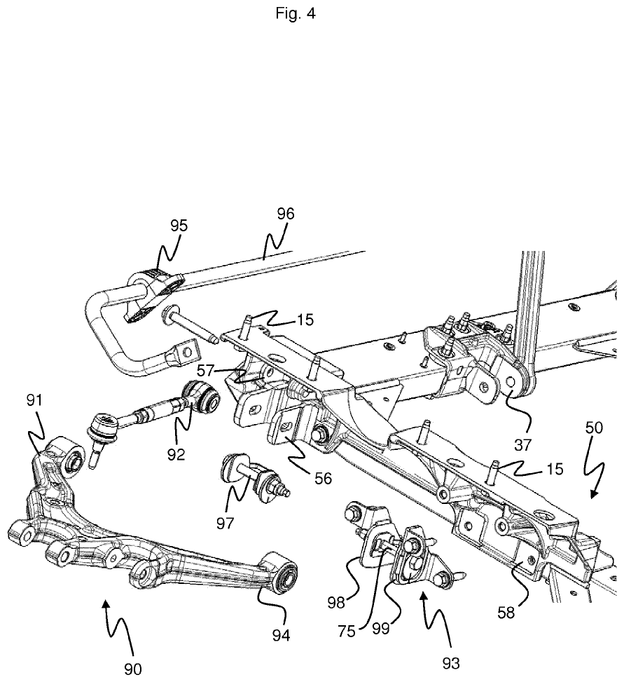

FIG. 4 is an exploded schematic view in perspective of the suspension elements associated with the casting secured on the cradle;

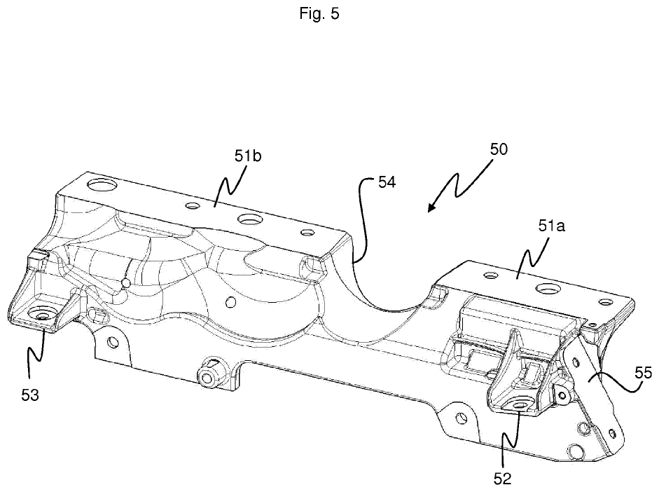

FIG. 5 is a schematic view in perspective of an inner face of the casting designed to be secured on the cradle;

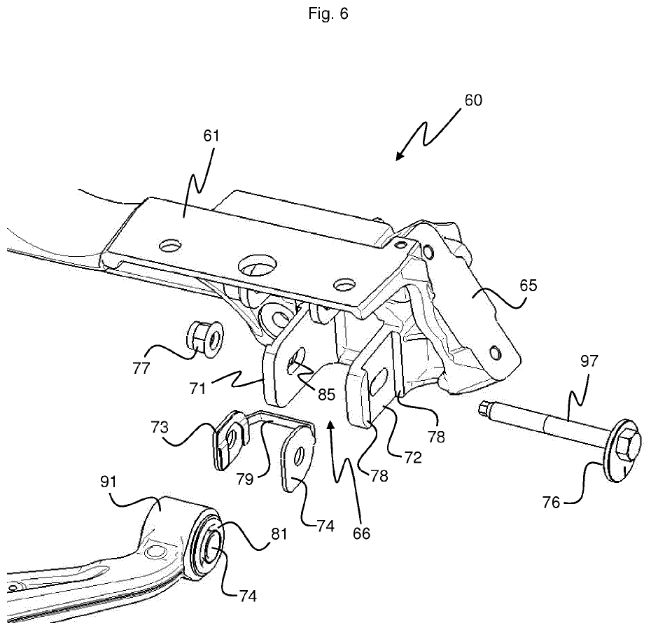

FIG. 6 is an exploded schematic view in perspective of an embodiment of the device according to the invention;

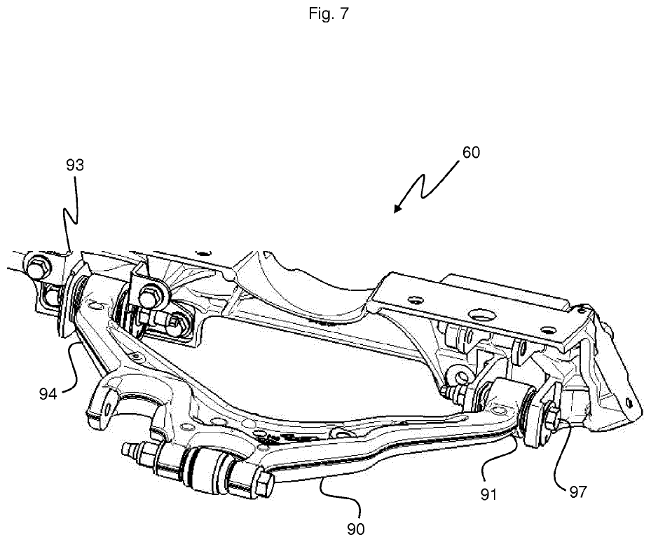

FIG. 7 is a schematic view in perspective showing fitting of a suspension triangle by means of the device of FIG. 6;

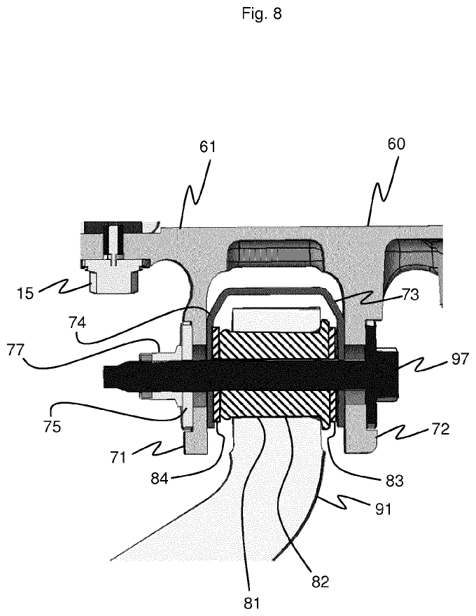

FIG. 8 is a partial view in cross section of the device according to the invention.

The assembly according to the invention makes it possible to obtain compact, light strong parts on which the suspension elements can easily be fitted.

The design of the invention is based on the choice of producing an aluminum casting which permits the connection between the side rails of the vehicle body structure and the cradle, while providing the suspension elements with necessary fastenings. Thus, the anti-camber bar, the lower suspension triangle and clamp rocker bar can be secured firmly, and with adequate interfaces, on the casting. The gravity casting process associated with a machining operation provides significant latitude in the forms which are permitted and their precision. In addition, the use of the casting makes it possible to integrate all of the functions in a minimum amount of space, thus complying with the vehicle architecture constraints.

In the exemplary embodiment described hereinafter by way of illustration on a vehicle with rear-wheel drive, it will be understood how the casting also provides the vehicle structure with rigidity, in particular at the rear side rails, which are to a large extent dented so as to permit the passage of the drive shaft.

A description is now provided of how the casting performs three essential functions, comprising, as well as those of assembling the rear cradle on the side rails and strengthening the structure, those of providing the interfaces of the suspension elements.

FIG. 1 shows an aluminum cradle 30 assembly for a vehicle on a body structure comprising a right lateral side rail 10 and a left lateral side rail 20, both made of aluminum. The body structure part 40 which is described in particular here for a vehicle with rear-wheel drive constitutes a rear part of the body structure. Persons skilled in the art will easily be able to transpose the teaching of the invention, while reading the remainder of the description, to a front-wheel drive vehicle if they feel this is necessary.

In the embodiment disclosed, each of the rear side rails 10, 20 comprises a respective front face 11, 21 to be secured on a central body part constituting the passenger space of the vehicle, which passenger space itself is preferably made of aluminum which is extruded, stamped, or bent, and assembled by means of adhesion-riveting. For their part, the side rails 10, 20 are preferably made of hot-extruded aluminum.

The outer lateral face of each side rail 10, 20, in other words each side rail face which is oriented towards an outer side of the vehicle, comprises a conical concave depression 12, 22, with a point which is oriented downwards, which depression is open both on the deepest side (base of the cone) on the upper face, and on the side of the axis of the cone on the outer lateral face of the side rail, in order to permit passage of a shock absorber (not represented).

The side rails 10, 20, which have dimensions such as to support an engine assembly, are connected at their upper part by a central cross-member 42, and at their rear end by a rear end cross-member 41, both made of aluminum which is extruded, welded and/or screwed on. The right lateral side rail 10, the left lateral side rail 20, and the central cross-member 42 are for example straight, hot-extruded aluminum profiles. The rear end cross-member 41 is for example an aluminum profile which is extruded, then hot-curved. Preferably, the right lateral side rail 10 and the left lateral side rail 20 are welded at each end of the central cross-member 42, and the rear end cross-member 41 is secured by being screwed on the rear ends of the side rails 10, 20.

An aluminum casting 50 comprises an upper face 51, which is secured below the right lateral side rail 10. Preferably, the upper face 51 comprises a rear part 51a which is secured at a rear position relative to the point of the half-cone of the concave depression 12, and a front part 51b which is secured at a front position relative to the point of the half-cone of the concave depression 12. Thus, the aluminum casting 50 makes it possible to reinforce the side rail 10 below the location of the point of the half-cone formed by the concave depression 12. Symmetrically, an aluminum casting 60 comprises an upper face 61 which is secured below the left lateral side rail 20 in a manner which is symmetrical comparable to the aluminum casting 50, in order to reinforce the side rail 20 below the location of the point of the half-cone formed by the concave depression 22.

More particularly, in this case, the cradle 30 is a rear cradle which comprises a right lateral beam 31 and a left lateral beam 32, which are connected by a rear transverse beam 34 and by a front transverse beam 33. The beams 31 to 34 can be made of aluminum which is stamped and bent. An embodiment of the beams 31 to 34 in the form of aluminum profiles, for example obtained by hot extrusion, provides better mechanical and thermal resistance. The front transverse beam 33 projects from each side of the cradle in order to be secured better on the central unit of the vehicle. The rear transverse beam 34 supports a substantially central stirrup 37 with which it is rendered integral, for example by means of a screwed connection, and on which a reinforcement tie rod 38 is secured for an engine torque absorption rocker bar (not represented).

An oblique beam 35 which is oriented from the beam 31 towards the interior of the passenger space, while passing through the beam 33, and an oblique beam 36 which is oriented from the beam 32 towards the interior of the passenger space, while passing through the beam 33, make it possible to diffuse the forces by absorption on the tunnel (not represented) for the passage of cables and ducts from the front of the passenger space to the engine compartment which is situated at the rear of the vehicle.

At least a lower part of the casting 50 and of the casting 60 is secured on the cradle 30. Lower part means any possible part of the casting which is situated below the upper face 51. In the embodiment illustrated in FIG. 5, the aluminum casting 50 comprises in its lower part a protrusion 52 which is situated at the rear of an inner lateral face, and a protrusion 53 which is situated at the front of the inner lateral face. Inner lateral face means any face of the casting which is oriented towards, in other words facing towards, the interior of the engine compartment. The protrusions 52, 53 can be on lower parts of different levels. Each protrusion 52, 53 comprises a surface which is substantially parallel to the upper face 51 of the aluminum casting 50, and pierced substantially in its center in order to permit the passage of a screw for securing on the upper face of the lateral beam 31. Surfaces which are substantially parallel to one another means surfaces, the lines of which perpendicular to their planes diverge from one another for example by an angle of less than 10°. Similarly, the aluminum casting 60 comprises on its lower part a protrusion 62 which is situated at the rear of an inner lateral face, and a protrusion 63 which is situated at the front of the inner lateral face, as can also be seen in FIG. 1.

The casting 50 comprises a through-opening 54 from the inner lateral face to the outer lateral face, in order to permit passage of the drive shaft of the engine assembly towards the right wheel (not represented). Thus, the casting 50 prevents the side rail 10 from becoming fragile as a result of passage of the drive shaft passing through it. The opening 54 can be produced in tubular form, but this embodiment requires a casting which is high enough to contain the diameter of the tubular form necessary for the passage of the drive shaft.

In order to reduce the size of the casting 50, the opening 54 is in the form of a semi-cylindrical concave depression formed in the upper face 51 of the casting 50. The lower face of the side rail 10 thus comprises a semi-cylindrical concave depression 13, which is designed to form a hollow cylinder with a diameter sufficient for the passage of the drive shaft, when the semi-cylindrical concave depression 13 is disposed above and facing the opening 54 in the form of a semi-cylindrical concave depression. The rear part 51a of the upper face 51 is then secured in a rear position relative to the semi-cylindrical concave depression constituting the opening 54, and the front part 51b is then secured in a front position relative to the semi-cylindrical concave depression constituting the opening 54. Thus, the casting 50 reinforces with a minimal size the location of the side rail 10 in which a sufficient opening can be formed by means of concave depression, in combination with that of the casting for the passage of the drive shaft, and also, in its near vicinity the opening 12 can be formed, also by concave depression, which opening is sufficient for the passage of the shock absorber (not represented) as close as possible to the side rail 10.

Similarly, the casting 60 comprises a through opening from the inner lateral face to the outer lateral face, in order to permit passage of the drive shaft of the engine assembly towards the left wheel (not represented).

It is possible to obtain each aluminum casting by molding under pressure, by taking the well-known necessary measures to avoid the phenomena of shrinkage when cooling and micro-bubbles, for example by means of use of a sink head. In order to obtain more easily the mechanical characteristics required, each casting 50, 60 is obtained by gravity casting of aluminum. Advantageously in comparison with a sand mold, gravity die casting permits use and re-use of a permanent mold.

The gravity die casting process makes it possible to obtain particularly remarkable mechanical characteristics of each casting 50, 60, by use of an appropriate aluminum alloy, in particular an aluminum alloy comprising 6.5 to 7.5% silicon and 0.25 to 0.45% manganese, which provides resistance to traction of between 285 and 295 MPa.

The upper face 51 and 61 respectively of the part 50 and 60 respectively aluminum casting is secured below the side rail 10 and 20 respectively by means of screws 15. In a comparable manner, the lower part(s) 52, 53 and 62, 63 respectively of the aluminum casting 50 and 60 respectively are secured on the upper face of the beam 31 and 32 respectively of the cradle 30 by screws. Steel screws are preferably used for the mechanical characteristics of this metal which are particularly appropriate for the securing, previously subjected to a zinc-nickel treatment because of its characteristics of making the steel in contact with the aluminum compatible.

As illustrated by FIG. 3, the aluminum casting 50, and likewise symmetrically the aluminum casting 60, comprises a first pair of fins 56 on a lateral wall, in order to mount an end of an arm or of a first branch 91 of a suspension triangle. In particular, the pair of fins 56 extends perpendicularly to the outer lateral face of the aluminum casting 50, below the rear part 51a of the upper face 51. Each fin is pierced substantially in its center by an opening which permits passage of a shaft or screw 97 for retention of the arm or first branch 91 of a suspension triangle.

The aluminum casting 50, and likewise symmetrically the aluminum casting 60, comprises a second pair of fins 57 on said lateral wall, in order to mount an end of a clamp rocker bar 92.

The aluminum casting 50, and likewise symmetrically the aluminum casting 60, also comprises on the lateral wall an interface 58, 59 for securing of a clevis 93. As illustrated by FIG. 4, the clevis 93 comprises two vertical walls for mounting of an end of a second branch 94 of a suspension triangle. Making the clevis 93 of steel makes it possible to bend an upper part oriented towards the exterior and a lower part oriented towards the interior of each vertical wall, without loss of mechanical quality, in order to be applied respectively against two protrusions 59 and against two vertical flattened parts 58 of the interface in order to be secured on them by means of screws.

In addition, the aluminum casting 50, and likewise symmetrically the aluminum casting 60, comprises an oblique flattened part 55, respectively 65, on which a bearing 95 of a stabilizing bar 96 is secured. Making the bearing 95 of polymer material contributes towards the lightening of the assembly.

FIGS. 6 and 7 show in greater detail how to secure a suspension arm on the aluminum casting 60. The following explanations can easily be transposed to the aluminum casting 50 by symmetry relative to the longitudinal axis of the vehicle, which is also the axis of symmetry of the side rail 10 relative to the side rail 20.

It should be noted that the device according to the invention belongs to an area which is subjected to high mechanical stress, since it is directly connected to the wheel of the vehicle.

FIG. 6 shows the end of the suspension arm 91 which comprises a cylindrical articulation ring 81 (bushing). The cylindrical ring, which is sometimes also known as a bearing, provides a pivot connection between the end of the suspension arm 91 and the aluminum casting 60.

For this purpose, the end of the suspension arm 91 comprises a hollow cylindrical end in order to accommodate therein the cylindrical ring 81. As can be seen in FIG. 8, the cylindrical ring 81 comprises an elastomer cylinder 82 which is pierced in its center in order to permit the passage of a screw 97. The outer generatrices of the elastomer cylinder 82 are directly or indirectly integral with the inner generatrices of the hollow cylindrical end. Each lateral end of the cylindrical ring 81 is integral with a metal disk 83, 84, which forms the interface with the surrounding parts. Each disk 83, 84, which is generally made of steel, is also pierced in its center in order to permit the passage of the screw 97.

The assembly principle is to accommodate then clamp the cylindrical ring 81 between two support planes. The connection is consolidated by means of an axial element of the screw type, which thus makes it possible to clamp the cylindrical ring 81 between the two flat supports by permitting the rotation of the hollow cylindrical end of the suspension arm around the screw, by torsion of the elastomer cylinder 82 which dampens the transmission of vibrations between the wheels and the aluminum casting 60, and consequently between the wheels and the lateral side rail 20 below which the upper face 61 of the casting 60 is secured.

The aluminum casting of the device for connection between the aluminum lateral side rail of the vehicle body structure and the end of the suspension arm also comprises a lateral wall from which there extends a suspension arm interface comprising a pair of fins which are spaced apart from one another by an air gap value which is greater than the length of the cylindrical ring 81, so as to mount the end of the suspension arm. The air gap between the two fins which are designed to accommodate the cylindrical articulation ring 81 thus provides assembly play which, after tightening of the screw, is reabsorbed so as to guarantee the satisfactory operation of the device, by placing the fins perfectly against the lateral surfaces of the cylindrical articulation ring 81.

An embodiment of the suspension arm interface can comprise the steel clevis 93, which then comprises a pair of fins 98, 99 made of steel, and which is screwed onto the aluminum casting 60, as is the case for the end branch 94 of the suspension triangle 90 in FIG. 7, or which is screwed onto the aluminum casting 50, as is the case for the end branch 94 of the suspension triangle 90 in FIG. 4.

A particularly advantageous embodiment of the suspension arm interface comprises a pair of fins 56, 66 which form an integral part of the aluminum casting 50, 60, with subjection to a machining operation after leaving the foundry. The machining operation has the objective in particular of obtaining the smallest possible assembly play to be eliminated, while facilitating the assembly of the ring 81, irrespective of the machining dispersions of the fins in casting and production of the articulation ring (bushing). This second embodiment is the one applied to the suspension arm which constitutes the end branch 91 of the suspension triangle 90 in FIGS. 4 and 7.

The second embodiment has the advantage of being less bulky and less heavy than that of the steel clevis 93. The pair of fins 56 in FIG. 4 and the pair of fins 66 in FIG. 6, coming directly from the aluminum casting, are able to clear space to the advantage of a clamp rocker bar interface which comprises the pair of fins 57, in order to mount an end of the clamp rocker bar 92, and which also forms an integral part of the aluminum casting 50 or 60, with subjection to a machining operation after leaving the foundry. It will be remembered that, in a manner known per se, the clamp rocker bar acts on the parallelism of the wheels of a single axle.

However, aluminum is a soft material compared with steel, when the disks 83, 84 are made of this metal. In order to prevent the hammering of the casting fins by the cylindrical articulation ring 81, the device comprises at least one wedge 73, and if necessary a wedge 74, inserted on the one hand between the disk 83 at the end of the cylindrical ring 81 and an inner face of the fin 72 of the pair of fins 66, and/or between on the one hand the disk 84 at the end of the cylindrical ring 81 and an inner face of the fin 71 of the pair of fins 66 in FIGS. 6 and 8, or of the pair of fins 56 in FIG. 4.

Thus, the wedges make it possible to increase the support surface of the cylindrical ring 81 on the fins. The force is distributed better, and the hammering is limited. However, these wedges also have production dispersions, which adds an extra link in the chain of assembly dimensions. In other words, it is necessary to enlarge the nominal air gap, so as to ensure minimal assembly play according to the production dispersions of the parts, so as to facilitate the assembly.

Assembly is facilitated by a small bar 79 which connects two wedges 73, 74. Thus, it is possible to introduce two wedges 73, 74 simultaneously between the two fins 71, 72, simply by pushing the small bar 79.

The pair of fins 66, made of aluminum, comprises a first fin 72 with a bulky base in order to maintain its position rigidly, so as to act as a geometric reference at the end of the suspension arm 91, and consequently at the triangle, when the arm is a branch thereof. The pair of fins 66 also comprises a second fin 71 with a thinned base, in order to allow its opposite end to be oriented towards the first fin 72, so as to clamp the cylindrical ring 81 between the two fins. The thinning of the fin is preferably carried out by machining, so as to make the fin flexible enough to approach the cylindrical ring 81, without making it too flexible to withstand the mechanical forces to which it is subjected. The compromise between flexibility and resistance to mechanical stresses depends on numerous factors, including the technical characteristics of the vehicle and the casting alloy used. For each type of vehicle, a good compromise is obtained by iterations of calculation, in a manner known per se by persons skilled in the art. Thus, for example, in a process for production of the aluminum casting by gravity casting in a die mold with a grade of aluminum known as AlSi7Mg0.3KT6, good rigidity of the fin 72 is easily obtained. A good compromise between flexibility and mechanical strength of the fin 71 can be obtained by reducing the thickness of the base of the fin 71 within a range varying from a third to half of the thickness of the base of the fin 72, preferably by providing the outer face of the base of the fin 71 with a concave cylindrical form.

The device comprises a screw 97 which passes through the fins 71, 72, the cylindrical articulation ring 81, and, when they exist, the wedges 73, 74, in order to reduce by clamping the air gap value of the pair of fins 66 of the suspension arm interface. The same applies to the pair of fins 56, and comparably to the fins 98, 99 of the clevis 93.

Each fin 71, 72 comprises an oblong window 85 with a length substantially parallel to the upper face 61 of the aluminum casting. During the phase of assembly and/or of development of the end of the suspension arm, this form makes it possible to move the cylindrical articulation ring 81, and consequently the end of the suspension arm of the aluminum casting, closer and further away by sliding the body of the screw 97 in the oblong window 85, the width of which is very slightly greater than the diameter of the body of the screw 97.

An eccentric disk 76 is secured on the body of the screw against the head of the screw 97. In other words, the center of the eccentric disk 76 is offset relative to the axis of the screw 97. The screw 97 penetrates into the oblong window in the fin 72, until the eccentric disk 76 is placed against the outer face of the fin 72.

The outer face of the fin 72 comprises a channel between two shoulders, each forming a slide 78 against which the portion of the eccentric disk 76 is applied. The shoulders are spaced apart from one another by a distance which is very slightly greater than the diameter of the eccentric disk 76, such that it is possible to slide the body of the screw 97 in the oblong window 85 by turning the screw 97. An eccentric washer 75 can also be provided, similar to the eccentric disk 76, to be applied against the outer face of the fin 71. The eccentric washer 75 comprises a bore with the diameter of the screw 97, inside which a rib or key penetrates into a groove formed along the body of the screw 97, such that the washer 75 turns with the screw in a manner identical to that of the eccentric disk 76. Thus, the adjustment obtained by the angular position of the eccentric disk 76 is carried over to the fin 71 by the washer 75. When the required position of the screw 97, and consequently of the end of the suspension arm, has been reached, the screw 97 is prevented from turning, and a nut 77 is secured on the end of the screw opposite the head, in order to block the screw in rotation and obtain the required clamping. This feature of the device is advantageous when the suspension arm constitutes a branch of a lower suspension triangle. A similar eccentric mechanism is implemented on the fins 98, 99 of the clevis 93 for the other branch of the lower triangle.

Thus, by moving the ends of the suspension arms 91 and 94 away by means of the eccentric disk in an identical manner relative to the aluminum casting, the top of the wheel of the center of the vehicle is brought closer. Reciprocally, when the ends of the suspension arms 91 and 94 are brought closer by means of the eccentric disk in an identical manner relative to the aluminum casting, the top of the wheel of the center of the vehicle is moved away. The device thus makes it possible to adjust the vehicle bodywork.

1-10. (canceled)

11. A device for connection between an aluminum lateral side rail of a vehicle body structure and a suspension arm end which comprises a cylindrical articulation ring, the device comprising:
an aluminum casting comprising an upper face which is secured below said side rail, and a lateral wall from which there extends perpendicularly to an outer lateral face at least a first suspension arm interface comprising a pair of fins which are spaced apart from one another by an air gap value greater than the length of said cylindrical ring, so as to mount said suspension arm end.

12. The device as claimed in claim 11, wherein the first suspension arm interface comprises a pair of fins which form an integral part of the aluminum casting, with subjection to a machining operation after leaving the foundry.

13. The device as claimed in claim 12, wherein said pair of fins comprises a first fin with a bulky base in order to maintain its position rigidly, and a second fin, with a thinned base, in order to allow its opposite end to be oriented towards said first fin, so as to clamp said cylindrical ring between the two fins.

14. The device as claimed in claim 12, further comprising at least one wedge inserted between an end of said cylindrical ring and an inner face of the pair of fins.

15. The device as claimed in claim 14, wherein the at least one wedge includes two wedges connected by a small bar.

16. The device as claimed in claim 11, wherein the aluminum casting comprises a clamp rocker bar interface which comprises a pair of fins in order to mount an end of the clamp rocker bar, and which forms an integral part of the aluminum casting, with subjection to a machining operation after leaving the foundry.

17. The device as claimed in claim 11, wherein the first or a second suspension arm interface comprises a steel clevis which comprises a pair of fins and is screwed onto the aluminum casting.

18. The device as claimed in claim 11, further comprising a screw which passes through the fins and the cylindrical articulation ring in order to reduce by clamping the air gap value of the pair of fins of a single suspension arm interface.

19. The device as claimed in claim 18, wherein each fin comprises an oblong window with a length substantially parallel to said upper face of the aluminum casting, such that it is possible to bring the cylindrical articulation ring, and consequently the suspension arm end of the aluminum casting, closer and further away by sliding the body of said screw in the oblong window.

20. The device as claimed in claim 19, wherein said screw comprises an eccentric disk in order to be placed against a fin face which comprises at least one slide against which the portion of the eccentric disk is applied, such that it is possible to slide the body of said screw in the oblong window by turning said screw.
